(19) United States
(12) Patent Application Publication
(10) Pub. No.: US 2015/0106021 A1
(43) Pub. Date: Apr. 16, 2015

(54) INTERACTIVE VISUAL ANALYSIS OF CLINICAL EPISODES

(71) Applicant: International Business Machines Corporation, Armonk, NY (US)

(72) Inventors: David H. Gotz, Purdys, NY (US); Adam Perer, Long Island City, NY (US); Fei Wang, Ossining, NY (US)

(73) Assignee: International Business Machines Corporation, Armonk, NY (US)

(21) Appl. No.: 14/051,921

(22) Filed: Oct. 11, 2013

(51) Int. Cl. G06F 19/00

(52) U.S. Cl. CPC G06F 19/3443
USPC 702/19

(57) ABSTRACT

Methods, systems, and articles of manufacture for exemplary visual analytics are provided herein. Visual analytics techniques are provided that combine pattern mining and temporal event visualization-based techniques. Visual episode query tools allow interactive specification of episode definitions and are combined with on-demand data analytics that perform pattern mining to help discover important intermediate events within an episode, and dynamic information visualization that allow interactive exploration and analysis of clinical event sequence data. The disclosed interactive visualization techniques identify events that impact outcome and how those associations change over time.

### FIELD OF THE INVENTION

Embodiments of the invention generally relate to information technology, and, more particularly, to visual analytic tools.

### BACKGROUND

Over time, a patient's medical condition can often evolve in complex and seemingly unpredictable ways. Moreover, variations in symptoms and diagnoses can often be observed within a population of patients, even when those patients are battling the same underlying disease. Similarly, a range of procedures, medications, and other interventions may be used by clinicians as they work to find treatment plans that yield the desired patient outcomes.

For this reason, scientists have long studied how variations in care and disease progression can lead to different outcomes. The most formal studies in this area often use randomized controlled trials (RCTs). While results from RCTs offer statistical rigor and serve as the “gold standard” for evidence-based medicine, they are expensive and time-consuming to conduct. This can makes the process slow and cumbersome when working to generate and explore new hypotheses. As a result, researchers have begun to take advantage of the growing repositories of observational data stored in electronic medical record (EMR) systems. For example, a number of platforms have been developed to analyze and make available vast volumes of this electronic data for ad hoc analyses.

A common type of retrospective study conducted using observational data is temporal event analysis. This type of investigation represents each patient's medical history as a sequence of time-stamped events. The temporal properties of these events, such as sequence and timing, are then analyzed to see how they impact a patient's eventual outcome. A variety of techniques have been used to gain insights from this sort of clinical event sequence data, ranging from data mining systems to interactive visualization-based tools.

While such mining-based and visualization-based methods have proven useful, they both suffer from significant limitations. First, mining-based methods often identify short snippets of frequently occurring patterns. The context in which these patterns occurs, however, is typically lost. This makes it hard to answer many meaningful questions, such as “Do the patterns typically appear early or late in an episode?” and “Does the importance of a pattern change at different stages of an episode?”

In contrast, visualization-based methods can illustrate episodes from start to finish, making clear the context surrounding intermediate events. Visualization methods, however, are typically limited to a small number of events or event types before becoming so complex that they are difficult if not impossible to interpret.

A need therefore exists for improved visual analytics techniques that combine both mining and visualization-based techniques to overcome the limitations outlined above.

### SUMMARY

In one aspect of the present invention, techniques for visual analytics are provided that combine both mining and visualization-based techniques. An exemplary computer-implemented method can include steps of obtaining an episode definition comprising a sequence of timestamped events for an entity that satisfy one or more constraints, wherein the episode definition comprises at least a starting milestone event, an ending milestone event and an outcome measure; translating the episode definition to a formal query; obtaining matching data that satisfies the formal query from a data repository for a plurality of entities, wherein for each of the entities, the matching data comprises a plurality of timestamped events comprising at least the starting milestone event and the ending milestone event; performing temporal pattern mining on the matching data to identify one or more event subsequence patterns that occur in a set of input episodes with a support value above a threshold; applying a statistical pattern analyzer to the identified event subsequence patterns to identify one or more correlations between the identified event subsequence patterns and the outcome measure that provide an indication of a degree of informativeness of a given pattern in terms of predicating an episode outcome; and visualizing one or more of the identified correlations, wherein at least one of the steps is performed by at least one hardware device.

According to further aspects of the invention, the episode definition optionally comprises one or more of milestone events, preconditions, an outcome measure and temporal constraints. The preconditions can specify one or more constraints that must be satisfied prior to a starting milestone. The episode definition can be interactively specified by a user.

According to further aspects of the invention, the temporal pattern mining comprises a frequent pattern mining. The frequent pattern mining can be applied to an overall event sequence returned by the formal query, and to each intermediate event sequence occurring between sequential milestone events.

According to further aspects of the invention, the visualization comprises visualizing one or more of a cohort overview, a milestone timeline and a mined pattern diagram. The exemplary milestone timeline illustrates a sequence of milestone events defining an overall episode. The exemplary mined pattern diagram visualizes a set of on two axes reflecting positive and negative coverage and optionally provides animation for temporal comparison.

Another aspect of the invention or elements thereof can be implemented in the form of an article of manufacture tangibly embodying computer readable instructions which, when implemented, cause a computer to carry out a plurality of method steps, as described herein. Furthermore, another aspect of the invention or elements thereof can be implemented in the form of an apparatus including a memory and at least one processor that is coupled to the memory and configured to perform noted method steps. Yet further, another aspect of the invention or elements thereof can be implemented in the form of means for carrying out the method steps described herein, or elements thereof, the means can include hardware module(s) or a combination of hardware and software modules, wherein the software modules are stored in a tangible computer-readable storage medium (or multiple such media).

These and other objects, features and advantages of the present invention will become apparent from the following detailed description of illustrative embodiments thereof, which is to be read in connection with the accompanying drawings.

### BRIEF DESCRIPTION OF THE DRAWINGS

FIG. 1 illustrates an exemplary visual analytics system incorporating aspects of the present invention;

FIG. 2 illustrates an exemplary episode that may be processed by the present invention;

FIG. 3A illustrates an exemplary graphical user interface that allows a user to specify an episode;

FIG. 3B illustrates an exemplary query result comprising the matching patients and the sequences of events that satisfy the episode constraints embodied in the exemplary query shown in FIG. 3A;

FIG. 4 is a flow chart illustrating an exemplary implementation of the pattern mining module incorporating aspects of the present invention;

FIG. 5 is a flow chart illustrating an exemplary implementation of the interactive visualization module incorporating aspects of the present invention;

FIGS. 6A through 6C illustrate exemplary visualizations for heart failure patients; and

FIG. 7 depicts an exemplary visual analytics system that may be useful in implementing one or more aspects and/or elements of the present invention.

### DETAILED DESCRIPTION

Aspects of the present invention provide improved visual analytics techniques that combine both mining and visualization-based techniques to overcome the limitations outlined above. According to one aspect of the invention, improved visual analytics techniques are provided that combine visual episode query tools to interactively specify episode definitions, on-demand data analytics that perform pattern mining to help discover important intermediate events within an episode, and dynamic information visualization capabilities to allow interactive exploration and analysis of clinical event sequence data. The query capabilities allow users to intuitively and quickly retrieve cohorts of patients that satisfy complex clinical episodes of interest. The disclosed visual analytics system then automatically leverages event pattern mining algorithms to uncover important events within the returned cohort. Finally, another aspect of the invention provides an interactive visual interface that lets users answer a range of interesting questions. The disclosed interactive visualization techniques identify events that impact outcome and how those associations change over time.

While the present invention is illustrated in the context of exemplary patients and clinical episodes, the present invention can be applied in any context where visual analytics are needed to combine both pattern mining and temporal event visualization-based techniques, as would be apparent to a person of ordinary skill in the art.

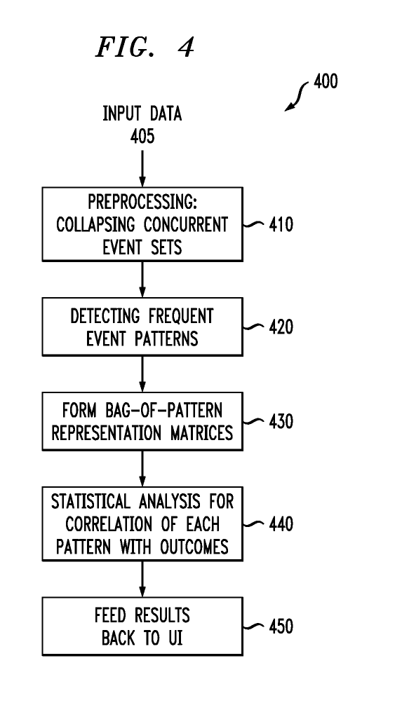

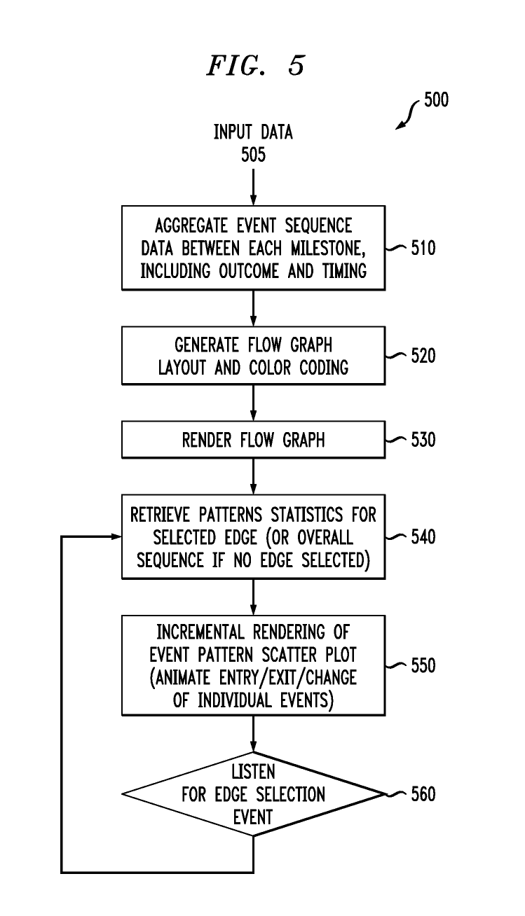

FIG. 1 illustrates an exemplary visual analytics system 100 incorporating aspects of the present invention. As shown in FIG. 1, the exemplary visual analytics system 100 comprises a visual query module 110, a pattern mining module 400, as discussed further below in conjunction with FIG. 4, and an interactive visualization module 500, as discussed further below in conjunction with FIG. 5. As discussed hereinafter, the exemplary visual analytics system 100 provides an intuitive user interface for authoring episode constraints and enables an interactive workflow for ad hoc event sequence analysis.

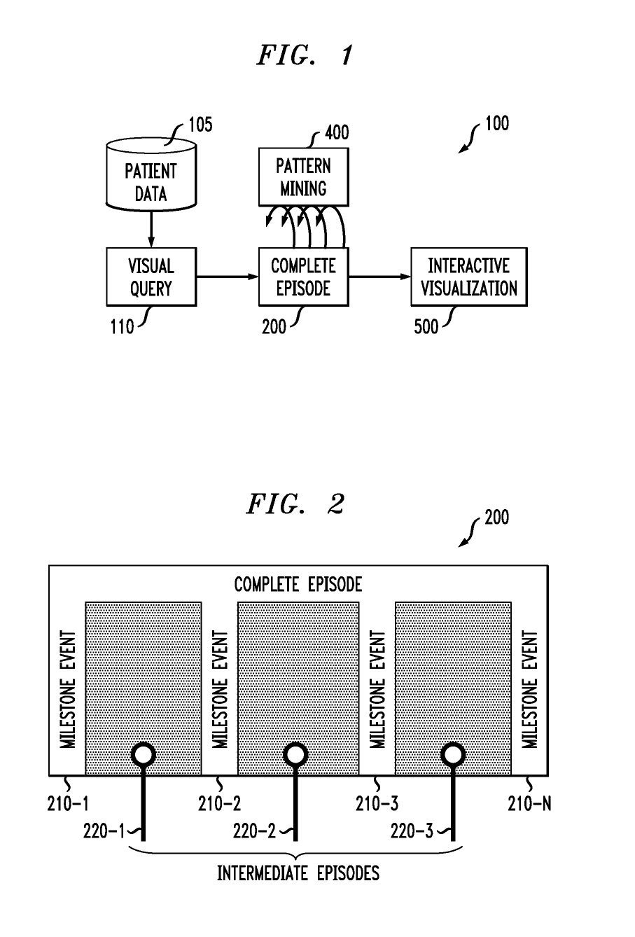

As shown in FIG. 1, patient data that matches the episode definition expressed in the visual query of the visual query module 110 is retrieved from a patient data repository 105 and passed to the pattern mining module 400. As discussed further below in conjunction with FIG. 2, in one exemplary implementation, mining is first performed on a complete episode 200. The same mining algorithm is then performed on intermediate episodes. As discussed further below in conjunction with FIG. 2, the four arrows shown in FIG. 1 going to the pattern mining module 400 corresponds to the four items in FIG. 2 (the complete episode 200, and the intermediate episodes 220-1, 220-2, an 220-3). Finally, as shown in FIG. 1, an interactive visualization module 500 allows users explore the results.

Visual Query Module

The exemplary visual query module 110 has two features: (1) an easy-to-use user interface component enabling the definition of a clinical episode specification, and (2) a query engine that converts the episode specification to an executable query and retrieves matching patient data from a clinical data warehouse.

FIG. 2 illustrates an exemplary episode 200 that may be processed by the present invention. As used herein, an episode comprises a sequence of clinical events for an individual patient that matches a specific set of constraints. For example, an episode may include all events for a patient between the initial onset of angina and an eventual diagnosis of heart failure. The rules that define which event sequences should be considered an episode are expressed as an episode specification. A valid specification comprises three elements: (1) milestone events, (2) preconditions, and (3) an outcome measure.

Each episode specification 200 has at least two milestone events 210-1 and 210-N to represent the start and end of the episode 200. For instance, in the earlier example, the onset of angina would be the start milestone 210-1 and heart failure would be the end milestone 210-N. In addition, intermediate milestones, such as milestone events 210-2 and 210-3, can be included to encode additional constraints. For example, an arrhythmia could be included as an intermediate milestone 210 to consider only patients who suffered from an irregular heartbeat prior to heart failure. Finally, time gaps can be included to ensure temporal constraints (e.g., at least two years between milestones).

Preconditions are a set of constraints, if any, that must be satisfied prior to the starting milestone. For example, a precondition could specify that only patients with a diagnosis of diabetes prior to the onset of angina be included.

The outcome measure specifies the way to evaluate the eventual result of an episode 200. Continuing the heart failure example, the outcome measure for a patient could be, for instance, the presence of an eventual heart value replacement procedure. The outcome measure definition is a critical element in the episode specification because the pattern mining algorithms look for event patterns within an episode that have strong correlations with good (or bad) outcomes.

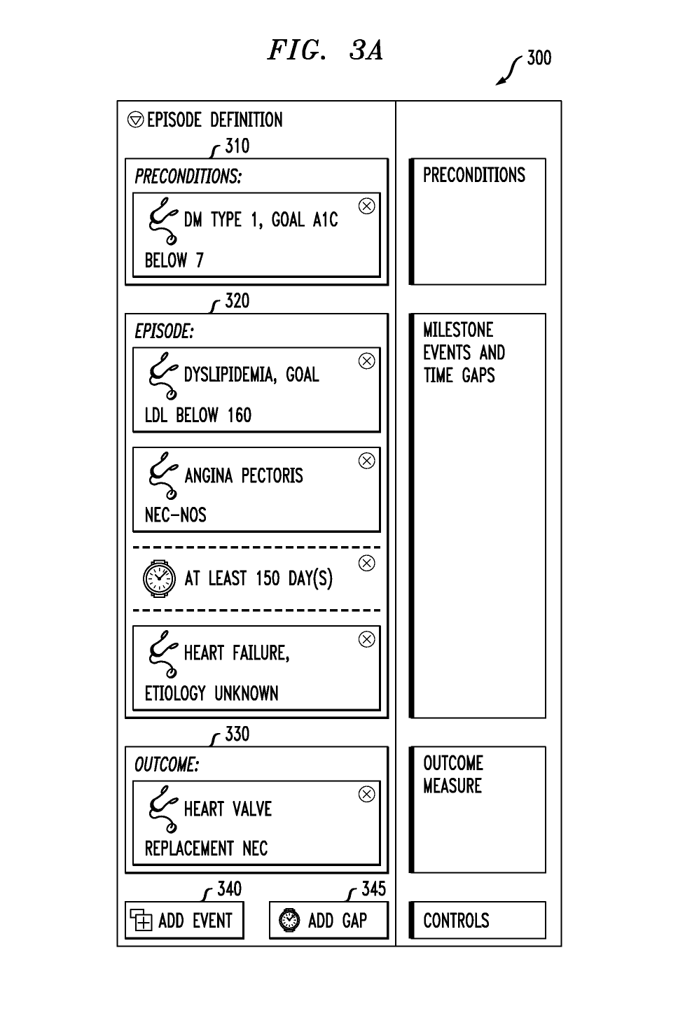

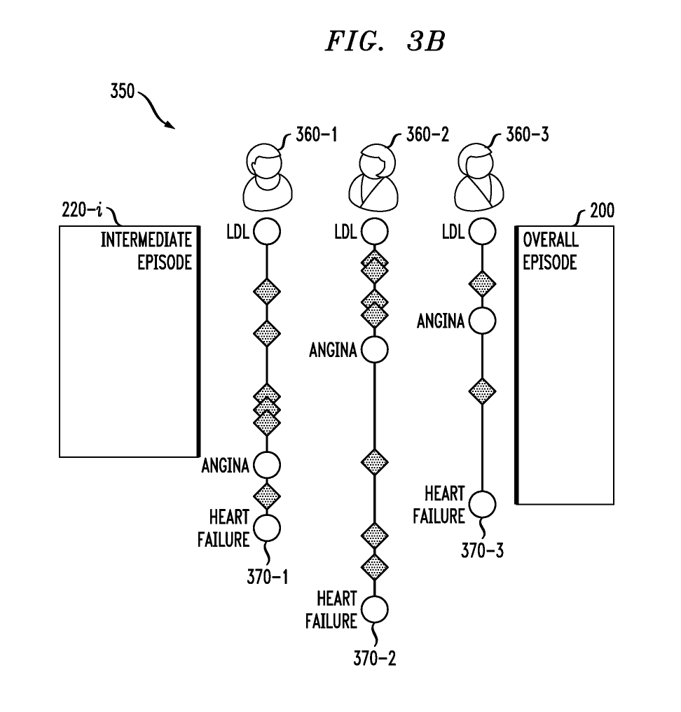

FIG. 3A illustrates an exemplary graphical user interface 300 that allows a user to specify an episode 200. Generally, the exemplary graphical user interface 300 allows users to interactively specify the types of episodes that they wish to analyze. An exemplary user interface 300 includes areas 310, 320, 330 corresponding to each of the three portions of a specification and optionally provides an “Add Event” control 340 and an “Add Gap” control 345 of a query panel, to allows users to insert new elements into the specification. Drag-and-drop interaction optionally allows the user to re-order elements of the specification or move them between the precondition, milestone, and outcome sections.

In one exemplary embodiment, once the user has finished defining the episode specification via the user interface 300, the visual query specification is translated into a formal query, expressed, for example, in Structure Query Language (SQL), that retrieves matching patient event episodes from the patient data repository 105. Generally, the query returns all patients having events (in the proper order) that satisfy the episode specification. Except for the step of translating to SQL, the exemplary visual analytics system 100 is independent of the underlying data source, thereby allowing for easy migration between data sources.

FIG. 3B illustrates an exemplary query result 350 comprising the matching patients and the sequences of events that satisfy the episode constraints embodied in the exemplary query shown in FIG. 3A. In this manner, the data returned by the query contains a cohort of patients whose medical records satisfy the episode specification. As shown in FIG. 3B, for each exemplary patient, such as patients 360-1 through 360-3, a list of events, such as events 370-1 through 370-3, is retrieved that contain the required milestone events 210, starting with the specification's first milestone 210-1 and ending with the last milestone 210-N. As shown in FIG. 2, the overall episode 200 can optionally be subdivided at milestone events 210 into a series of intermediate episodes, such as intermediate episodes 220-1 through 220-3. Thus, the list of events for a patient optionally also includes intermediate events that take place between the episode milestones 210. The full sequence of events is referred to as the overall episode 200. The span of intermediate events between any pair of neighboring milestones 210 is referred to as an intermediate episode 220.

Temporal Pattern Mining

As previously indicated, the pattern mining module 400 performs temporal pattern mining. FIG. 4 is a flow chart illustrating an exemplary implementation of the pattern mining module 400 incorporating aspects of the present invention. Generally, the exemplary the pattern mining module 400 performs Frequent Pattern Mining (FPM) first on the overall episode 200, then again on each of the intermediate episodes 220 retrieved by the visual query module 110. Generally speaking, there will be one round of pattern mining for the complete episode 200, and another n−1 rounds of pattern mining for an episode with n milestone events. In an exemplary episode where four milestones are defined, there are 3 additional rounds of pattern mining after the one round for the overall episode. As discussed hereinafter, the exemplary FPM engine comprises a Frequent Pattern Miner that operates during step 420 and a Statistical Pattern Analyzer that operates during steps 430 and 440.

As shown in FIG. 4, the exemplary pattern mining module 400 receives input data 405 comprising a set of detected episodes, corresponding support value (the exemplary miner looks for patterns with a support value above a threshold) and outcomes. The exemplary pattern mining module 400 then performs a preprocessing during step 410 comprising collapsing concurrent event sets.

Thereafter, during step 420, the pattern mining module 400 detects frequent event patterns using the Frequent Pattern Miner. The exemplary frequent pattern miner is responsible for detecting event subsequences that frequently occur in a set of input episodes 200. The miner defines a pattern as “frequent” based on the percentage of the input episodes in which the pattern appears, referred to herein as the pattern's support. As indicated above, the miner looks for patterns with a support value above a threshold. In one preferred embodiment, the support value is configurable. Users can also specify a minimum pattern length that can be any integer value greater than or equal to one. The pattern discovery employed by the exemplary pattern mining module 400 is based on a bitmap representation-based Sequential PAttern Miner (SPAM) (see, e.g., Jay Ayres et al., “Sequential PAttern Mining Using a Bitmap Representation,” Proc. of the 8^{th} ACM SIGKDD Int'l Conf. on Knowledge Discovery and Data Mining,” 429-35 (2002), incorporated by reference herein) which uses a search strategy that integrates a depth-first traversal of the search space with effective pruning mechanisms. The SPAM algorithm has been proven to be faster than traditional pattern mining approaches by an order of magnitude, especially when applied to relatively long episodes. The SPAM algorithm takes as input a set of event sequences (i.e., the episode data) and a user-specified support value, and produces as output a set of frequent patterns. The user-supplied minimum length threshold is then applied to filter out patterns that are too short.

Generally, the Statistical Pattern Analyzer looks for correlations between the mined patterns and the episode specification's outcome measure. The exemplary pattern mining module 400 employs the Statistical Pattern Analyzer during step 430 to form a bag-of-pattern (BoP) representation matrix for each episode from the identified set of frequent patterns. More formally, given a set of n frequent patterns, the BoP representation is an n-dimensional vector, where the i-th element of that vector stores the frequency of the i-th pattern within the corresponding episode. If there are m episodes (corresponding to m distinct patients), then an m×n episode-pattern matrix X=[x₁, x₂, . . . , xₙ,] is constructed whose (j,i)-th element indicates the number of times the i-th pattern appeared in the j-th episode. Thus, its i-th column xⱼ summarizes the frequency of the i-th pattern in all m episodes. An m dimensional episode outcome vector y can also be constructed, such that yⱼ is the outcome of the j-th episode. In the binary case, yᵢε(+1,−1) with +1 representing positive outcome and −1 representing negative outcome. Given this formulation, statistics are computed measuring the correlation between each xᵢ and y to measure the informativeness of the i-th pattern in terms of predicting an episode's outcome. For example, the Pearson correlation, P-value (to measure the significance of a correlation), information gain, and odds ratio can be computed.

During step 440, the Statistical Pattern Analyzer performs a statistical analysis for the correlation of each pattern with outcomes. Finally, the pattern mining module 400 provides the results to the exemplary graphical user interface 300 during step 450.

Interactive Visualization

As previously indicated, once the pattern mining module 400 has completed, the results are passed to the interactive visualization module 500. FIG. 5 is a flow chart illustrating an exemplary implementation of the interactive visualization module 500 incorporating aspects of the present invention. Generally, as discussed further below, the exemplary the interactive visualization module 500 provides a cohort overview, a milestone timeline, and mined pattern diagram.

As shown in FIG. 5, the exemplary interactive visualization module 500 processes a data input 505 comprising a set of event sequences and mining output (e.g., for each intermediate episode, a list of patterns and associated statistics; for the full episode, a list of patterns and associated statistics).

The interactive visualization module 500 initially aggregates the event sequence data between each milestone, including outcome and timing, during step 510. Thereafter, the interactive visualization module 500 generates a flow graph layout and color coding during step 520 and renders the flow graph during step 530.

The exemplary interactive visualization module 500 retrieves pattern statistics for the selected edge (or overall sequence if no edge is selected) during step 540. An incremental rendering of the event pattern scatter plot (animate entry/exit/change of individual events) is generated during step 550. Finally, the interactive visualization module 500 listens for an edge selection event during step 560.

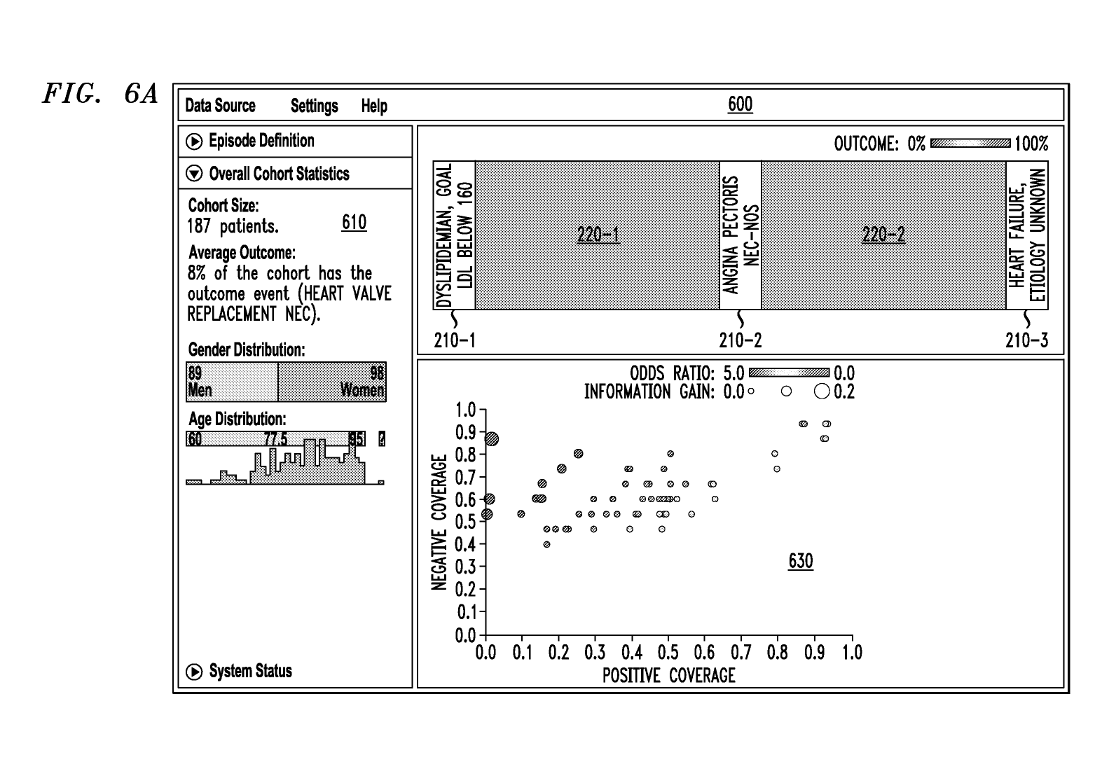

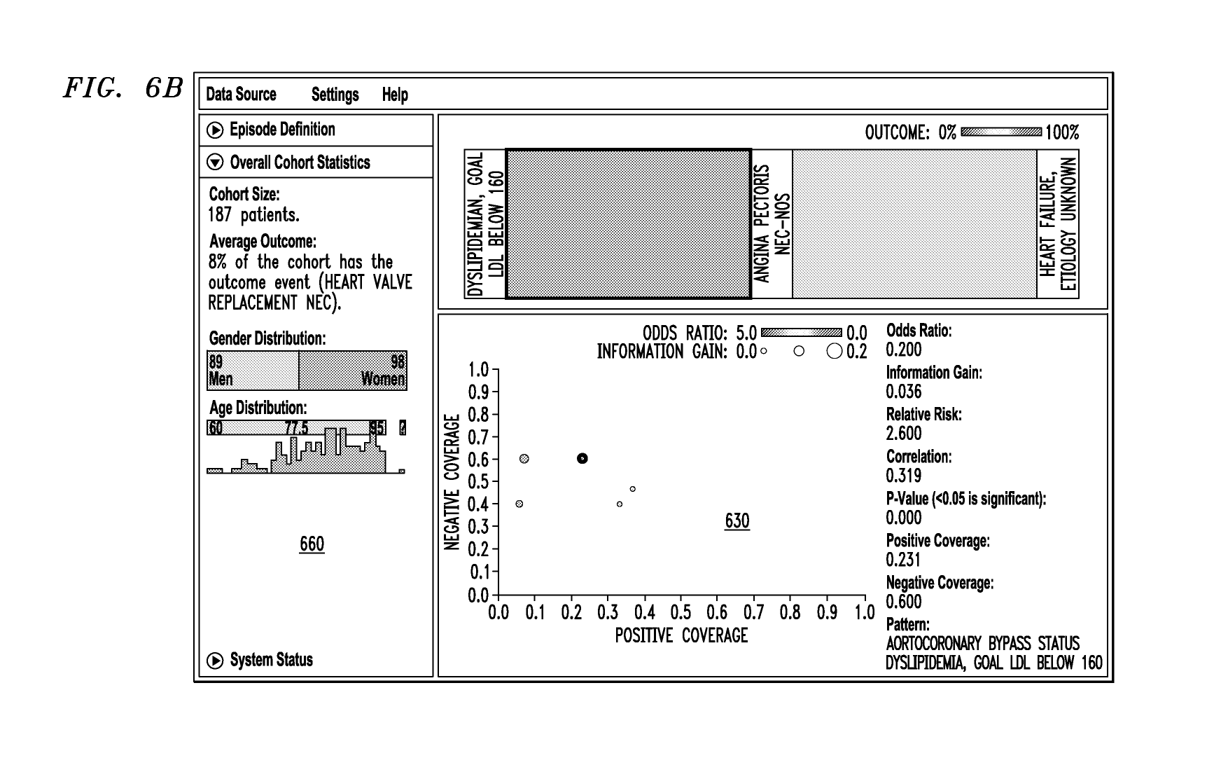

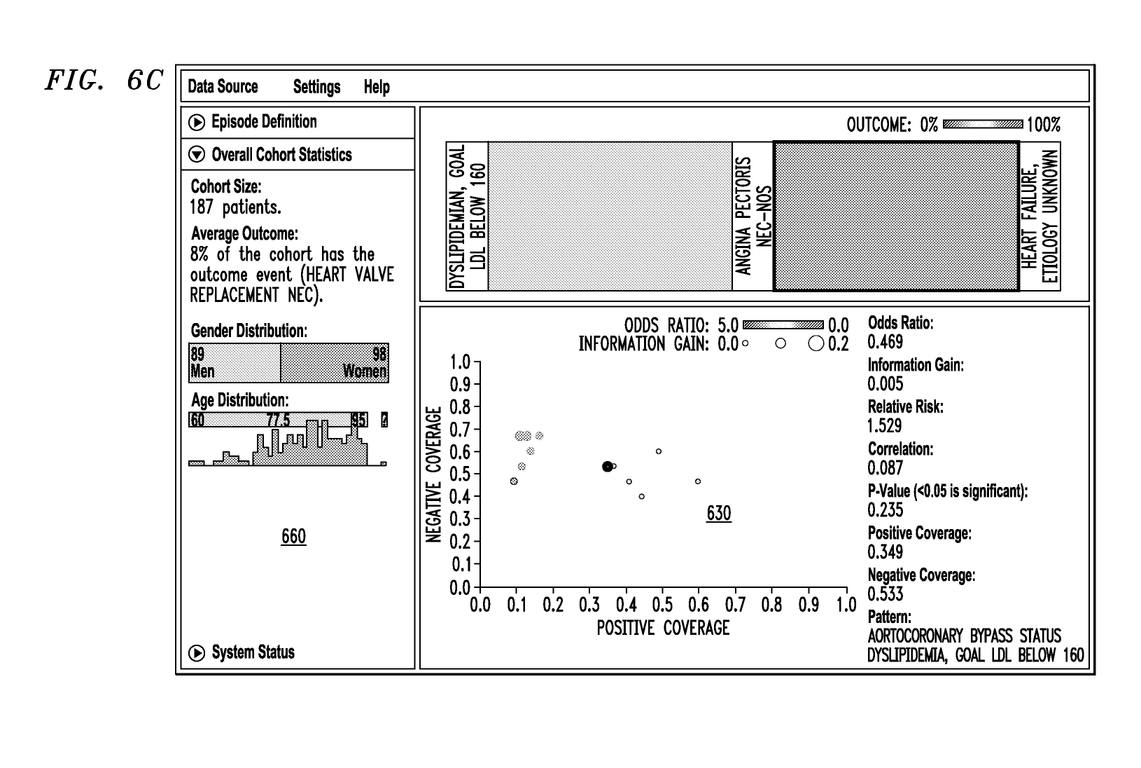

As indicated above, the exemplary the interactive visualization module 500 provides a cohort overview. FIGS. 6A through 6C illustrate exemplary visualizations 600, 630, 660, respectively, for heart failure patients. FIGS. 6A through 6C illustrate a different selection, with the overall episode shown in FIG. 6A, and each of two intermediate episodes shown in FIGS. 6B and 6C.

As discussed hereinafter, FIG. 6A provides a visualization 600 illustrating several patterns detected in the overall episode 200. The exemplary visualization 600 comprises a cohort overview visualization 610 showing gender and age distributions for the set of patients in the cohort returned by the query module 110. In addition to these charts, the sidebar panel 610 shows the number of patients in the cohort and the average outcome.

As indicated above, the exemplary the interactive visualization module 500 also provides a milestone timeline. Generally, the milestone timeline visualization illustrates the sequence of milestone events 210 that define the overall episode 200. As shown in FIG. 6A, for example, each milestone event 210 is represented as a vertical gray bar that can be labeled with the corresponding event type, such as Angina and Heart Failure. The milestone bars 220 are then connected by color-coded edges. These edges represent intermediate episodes 220 with a color, for example, representing the average outcome value. By default, the average outcome is normalized and mapped, for example, to a red-to-yellow-to-green color scale (e.g., green is for good outcomes; red is for bad outcomes). Alternative color scales or mappings can be used to support color-blind users. The milestone timeline is interactive and optionally allows users to select the overall episode or individual intermediate episodes via mouse clicks. FIG. 6A shows a milestone timeline with three milestone events 210-1, 210-2, 210-3.

From the overall episode shown in FIG. 6A, the user can select one of the two intermediate episodes 220-1 and 220-2 to obtain the visualizations 630, 660 shown in FIGS. 6B and 6C. FIG. 6B provides a visualization 630 illustrating a pattern associated with intermediate episode 220-1, corresponding to an eventual heart valve replacement. FIG. 6C provides a visualization 660 illustrating the same pattern later in the episode, but is no longer significant. The darker section(s) in the milestone timeline 210 indicates the scope of the selected episode.

As indicated above, the exemplary the interactive visualization module 500 also provides a mined pattern diagram. As shown in FIGS. 6A-6C, a mined pattern diagram 630 is rendered beneath the milestone timeline 210. The mined pattern diagram 630 visualizes a set of patterns and allows users to compare and inspect those patterns in various ways. First, each pattern is represented, for example, with a circle in a scatter plot. The x and y axes of the mined pattern diagram 630 reflect positive and negative coverage, respectively. Therefore, in the exemplary embodiment, patterns that appear primarily in patients with poor outcomes are located toward the top left. Patterns that appear primarily in patients with good outcomes are displayed toward the bottom right. The exemplary visualization

The size of each pattern's circle represents the information gain with larger circles being more meaningful, and the color of the circle represents the odds ratio. The exemplary embodiment adopts the same exemplary green-to-yellow-to-red color gradient used in the timeline 210 to encode the odds ratio. As a result, large red circles represent mined patterns that tend to lead to poor outcomes while large green circles represent patterns that led to good outcomes. Circles can be selected via mouse clicks to retrieve more information about the pattern. Upon selection, a sidebar can be displayed to the right of the scatter plot showing both the sequence of events that forms that pattern as well as the full set of statistics computed by the mining algorithm.

Coupled with the milestone timeline 210, the pattern diagram 630 provides hierarchical access to a complex set of mined pattern statistics. Users can select a region of the episode (i.e., intermediate episodes 220) via the timeline to see the corresponding set of patterns in the pattern diagram 630. They can then select one of those patterns to see the lowest level of information including the events in the pattern and detailed statistics such as p-values.

An important feature of the mined pattern diagram 630 is its support for temporal comparison. The significance of an event pattern can vary between different stages of an episode. For example, a specific pattern may be present in the overall episode 200, but without statistical significance with respect to outcome. Meanwhile, that same pattern may have a very strong association with outcome during an early intermediate episode 220 despite having absolutely no correlation with outcome later in time.

To help users understand these temporal changes in pattern significance, the exemplary mined pattern diagram 630 adopts animated transitions whenever the milestone timeline selection changes. Upon any such change, the pattern diagram component compares the “before” and “after” pattern sets and computes three distinct sets: incoming patterns, outgoing patterns, and remaining patterns. Incoming patterns are patterns that only exist in the newly selected portion of the episode. Circles representing these patterns are added to the diagram. Outgoing patterns are patterns that only exist in the previously selected portion of the episode. Circles for these patters are removed from the diagram. Most critical are the remaining patterns. The circles for these patterns are animated to new locations, colors and sizes to reflect the change in statistics for the patterns. Therefore, as users click from early to late term intermediate episodes 220, the bubble chart shows via animation the trajectory of a pattern as it becomes more (or less) significant and/or prevalent. If an individual pattern is selected (as in FIGS. 6B-6C), the selection is maintained across the animation, making it easy to observe how the properties of the pattern change between different portions of the episode.

One exemplary implementation comprises a web-based application, making it easily deployable to large user populations. The system uses Servlet technology, which is supported by the open-source Apache Tomcat server and a number of commercial offerings (e.g., IBM WebSphere). The server-side functionality is implemented in Java. The exemplary implementation connects to ICDA data sources (see, e.g., D. Gotz et al., “ICDA: A Platform for Intelligent Care Delivery Analytics,” AMIA Annual Symposium Proc., American Medical Informatics Association (2012), incorporated by reference herein), which are based on widely used standards such as ICD, CPT, and NDC.

Client-side functionality is developed using standard web technologies and allows access through any modem web browser. In addition to HTML, CSS, and JavaScript technologies, the exemplary implementation adopts a Dojo toolkit for user interface widgets. D3.js is used as a visualization toolkit on which to build the custom visualizations. The visualizations therefore rely on SVG as the underlying rendering technology.

Data adapters are provided to connect the prototype to two data sources, each with a somewhat different set of available clinical event types. As users interact with the query interface to add event constraints to an episode specification, type-ahead find is used to constrain the selections to only the event types present within the data. This allows users to quickly see what event types are available in a given dataset without deep prior knowledge of the data source.

### Use Cases

The disclosed method allows users to perform a wide range of ad hoc visual analysis tasks over event sequence data. Three exemplary use cases are discussed to show the types of investigations that the disclosed visual analytics system 100 supports.

One Pattern Over Time

This use case, shown in FIGS. 6A-6C, investigates a cohort of heart failure patients using ICD codes. Based on a user-defined episode specification, the exemplary visual analytics system 100 retrieves a cohort of patients who progress from dyslipidemia, to angina, to heart failure. Eight percent of the patients suffer from the outcome measure diagnosis: heart valve replacement. The cohort is roughly half men with a majority over 70. A large number of frequent patterns were found in the overall episode, but all were either neutral or negative indicators (yellow or green circles in FIG. 6A). Focusing in on specific intermediate episodes 220 returns fewer frequent patterns. One interesting pattern in this use case includes an aortocoronary bypass. This pattern is frequent in both the first and last intermediate episodes 220. However, it is far more significant in terms of its association with the outcome measure when observed toward the start of the episode. The visualization shows in FIG. 6C that while the pattern is still present in the second intermediate episode, it is less rare in the positive outcome subgroup at that stage of the disease progression which reduces its significance.

All Patterns Over Time

Another use case investigates a cohort of hypothyroidism patients using ICD codes. As instructed by the user, the exemplary visual analytics system 100 retrieves a cohort of patients who progress from obesity, to hypertension, to type-2 diabetes, to hypothyroidism. The outcome event of interest, found in 11.6% of the cohort, is a diagnosis of anemia. As one may expect, the group is mostly women with ages ranging from 53-95. It can be shown that there is an interesting change in the observed patterns as the user moves from the first to the last intermediate episodes. At the start of the progression, there are very few (e.g., seven) common patterns found (and all have negative associations). In the middle period, there are more patterns though with only week correlations with outcome. This can be illustrated in the way the circles cluster along the diagonal of the mined pattern diagram. For this particular analysis, the strong indicators for anemia are not evident until the third and final intermediate episode where the number of frequent patterns grows significantly and the odds ratios grow quite large.

Comparing Two Patterns

Another use case investigates a group of hypertensive patients using Hierarchical Condition Category (HCC) data. An exemplary episode specification is given that requires a sequence of four milestone conditions: hypertension, followed by hypertensive heart disease, followed by angina, followed by heart infection/inflammation. The outcome measure is specified as cardio-respiratory failure and shock. Episodes are retrieved for a cohort of patients matching this specification with just over 7% having negative outcomes. A large number of patterns (with minimum length of 1) are found in the overall sequence. The very same pattern can be found in the first intermediate episode and, the significance was even stronger than in the overall data. Further analysis shows that while the patients suffering arrhythmias during this early stage were among those most likely to have a bad outcome, there was another subgroup that was had much better outcomes. Patients with endocrine/metabolic disorders in the first intermediate episode had much better outcomes (hence the green circle in the chart). However, comparing p-values for these two patterns, it can be seen that only arrhythmias has a sufficiently small p-value to be statistically significant. The encocrine/metaboloic disorder pattern had a p-value of 0.094, which is greater than the commonly used 0.05 threshold for significance. Nonetheless, it remains a possible factor that could serve as a hypothesis for additional investigation.

Various aspects of the invention provide an exploratory visual analytics system for clinical episode analysis that combines a graphical query interface, event pattern mining and interactive visualization.

The techniques depicted in FIGS. 1, 4 and 5 can also, as described herein, include providing a system, wherein the system includes distinct software modules, each of the distinct software modules being embodied on a tangible computer-readable recordable storage medium. All of the modules (or any subset thereof) can be on the same medium, or each can be on a different medium, for example. The modules can include any or all of the components shown in the figures and/or described herein. In an aspect of the invention, the modules can run, for example, on a hardware processor. The method steps can then be carried out using the distinct software modules of the system, as described above, executing on a hardware processor. Further, a computer program product can include a tangible computer-readable recordable storage medium with code adapted to be executed to carry out at least one method step described herein, including the provision of the system with the distinct software modules.

Additionally, the techniques depicted in FIGS. 1, 4 and 5 can be implemented via a computer program product that can include computer useable program code that is stored in a computer readable storage medium in a data processing system, and wherein the computer useable program code was downloaded over a network from a remote data processing system. Also, in an aspect of the invention, the computer program product can include computer useable program code that is stored in a computer readable storage medium in a server data processing system, and wherein the computer useable program code is downloaded over a network to a remote data processing system for use in a computer readable storage medium with the remote system.

An aspect of the invention or elements thereof can be implemented in the form of an apparatus including a memory and at least one processor that is coupled to the memory and configured to perform exemplary method steps.

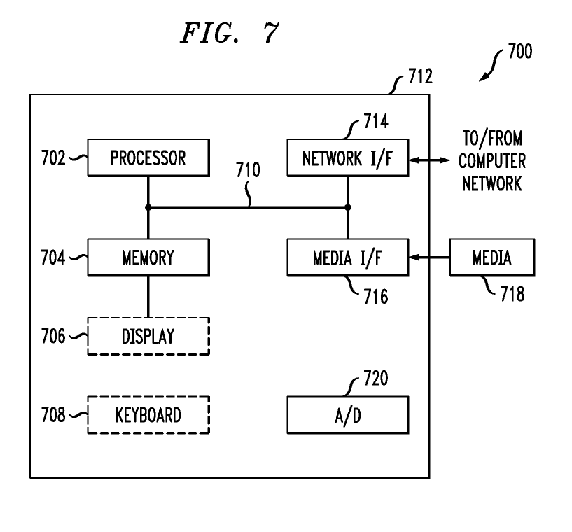

Additionally, an aspect of the present invention can make use of software running on a general purpose computer or workstation. With reference to FIG. 7, such an implementation might employ, for example, a processor 702, a memory 704, and an input/output interface formed, for example, by a display 706 and a keyboard 708. The term “processor” as used herein is intended to include any processing device, such as, for example, one that includes a CPU (central processing unit) and/or other forms of processing circuitry. Further, the term “processor” may refer to more than one individual processor. The term “memory” is intended to include memory associated with a processor or CPU, such as, for example, RAM (random access memory), ROM (read only memory), a fixed memory device (for example, hard drive), a removable memory device (for example, diskette), a flash memory and the like. In addition, the phrase “input/output interface” as used herein, is intended to include, for example, a mechanism for inputting data to the processing unit (for example, mouse), and a mechanism for providing results associated with the processing unit (for example, printer). The processor 702, memory 704, and input/output interface such as display 706 and keyboard 708 can be interconnected, for example, via bus 710 as part of a data processing unit 712. Suitable interconnections, for example via bus 710, can also be provided to a network interface 714, such as a network card, which can be provided to interface with a computer network, and to a media interface 716, such as a diskette or CD-ROM drive, which can be provided to interface with media 718.

Accordingly, computer software including instructions or code for performing the methodologies of the invention, as described herein, may be stored in associated memory devices (for example, ROM, fixed or removable memory) and, when ready to be utilized, loaded in part or in whole (for example, into RAM) and implemented by a CPU. Such software could include, but is not limited to, firmware, resident software, microcode, and the like.

A data processing system suitable for storing and/or executing program code will include at least one processor 702 coupled directly or indirectly to memory elements 704 through a system bus 710. The memory elements can include local memory employed during actual implementation of the program code, bulk storage, and cache memories which provide temporary storage of at least some program code in order to reduce the number of times code must be retrieved from bulk storage during implementation.

Input/output or I/O devices (including but not limited to keyboards 708, displays 706, pointing devices, and the like) can be coupled to the system either directly (such as via bus 710) or through intervening I/O controllers (omitted for clarity).

Network adapters such as network interface 714 may also be coupled to the system to enable the data processing system to become coupled to other data processing systems or remote printers or storage devices through intervening private or public networks. Modems, cable modems and Ethernet cards are just a few of the currently available types of network adapters.

As used herein, including the claims, a “server” includes a physical data processing system (for example, system 712 as shown in FIG. 7) running a server program. It will be understood that such a physical server may or may not include a display and keyboard.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

It should be noted that any of the methods described herein can include an additional step of providing a system comprising distinct software modules embodied on a computer readable storage medium; the modules can include, for example, any or all of the components detailed herein. The method steps can then be carried out using the distinct software modules and/or sub-modules of the system, as described above, executing on a hardware processor 702. Further, a computer program product can include a computer-readable storage medium with code adapted to be implemented to carry out at least one method step described herein, including the provision of the system with the distinct software modules.

In any case, it should be understood that the components illustrated herein may be implemented in various forms of hardware, software, or combinations thereof, for example, application specific integrated circuit(s) (ASICS), functional circuitry, an appropriately programmed general purpose digital computer with associated memory, and the like. Given the teachings of the invention provided herein, one of ordinary skill in the related art will be able to contemplate other implementations of the components of the invention.

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of another feature, integer, step, operation, element, component, and/or group thereof.

The corresponding structures, materials, acts, and equivalents of all means or step plus function elements in the claims below are intended to include any structure, material, or act for performing the function in combination with other claimed elements as specifically claimed.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

1. A method comprising the steps of:
obtaining an episode definition comprising a sequence of timestamped events for an entity that satisfy one or more constraints, wherein said episode definition comprises at least a starting milestone event, an ending milestone event and an outcome measure;
translating said episode definition to a formal query;
obtaining matching data that satisfies said formal query from a data repository for a plurality of entities, wherein for each of said entities, said matching data comprises a plurality of timestamped events comprising at least said starting milestone event and said ending milestone event;
performing temporal pattern mining on said matching data to identify one or more event subsequence patterns that occur in a set of input episodes with a support value above a threshold;
applying a statistical pattern analyzer to said identified event subsequence patterns to identify one or more correlations between said identified event subsequence patterns and said outcome measure that provide an indication of a degree of informativeness of a given pattern in terms of predicating an episode outcome; and
visualizing one or more of said identified correlations, wherein at least one of said steps is performed by at least one hardware device.

2. The method of claim 1, wherein said episode definition comprises one or more of milestone events, preconditions and an outcome measure.

3. The method of claim 2, wherein said episode definition comprises one or more temporal constraints.

4. The method of claim 2, wherein said preconditions specify one or more constraints that must be satisfied prior to a starting milestone.

5. The method of claim 1, wherein said episode definition is interactively specified by a user.

6. The method of claim 1, wherein said temporal pattern mining comprises a frequent pattern mining.

7. The method of claim 6, wherein said frequent pattern mining is applied to an overall event sequence returned by said formal query, and to each intermediate event sequence occuring between sequential milestone events.

8. The method of claim 1, wherein said visualizing step further comprises visualizing one or more of a cohort overview, a milestone timeline and a mined pattern diagram.

9. The method of claim 8, wherein said milestone timeline illustrates a sequence of milestone events defining an overall episode.

10. The method of claim 8, wherein said mined pattern diagram visualizes a set of on two axes reflecting positive and negative coverage.

11. The method of claim 10, wherein said mined pattern diagram provides animation for temporal comparison.

12. (canceled)

13. (canceled)

14. (canceled)

15. (canceled)

16. (canceled)

17. (canceled)

18. (canceled)

19. (canceled)

20. (canceled)

21. (canceled)

22. (canceled)

23. (canceled)

24. (canceled)

25. (canceled)
